(19) United States
(12) Patent Application Publication
(10) Pub. No.: US 2016/0359227 A1
(43) Pub. Date: Dec. 8, 2016

(54) MOBILE DEVICE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 14/986,129

(22) Filed: Dec. 31, 2015

(30) Foreign Application Priority Data
Jun. 8, 2015 (TW) 104118459

(51) Int. Cl. H01Q 1/50; H01Q 5/20

(52) U.S. Cl. CPC H01Q 1/50; H01Q 5/20

(57) ABSTRACT

A mobile device includes an antenna structure, a tunable circuit element, a bias tee element, an inductive element, and a capacitive element. The tunable circuit element is in the antenna structure. The bias tee element has a first input terminal for receiving a power signal, a second input terminal for receiving an RF (Radio Frequency) signal, and an output terminal for outputting a mixed signal. The inductive element is configured to remove high-frequency noise from the power signal. The capacitive element is configured to remove low-frequency noise from the RF signal. The output terminal of the bias tee element is coupled to a feeding point on the antenna structure. The antenna structure is excited by the mixed signal. The tunable circuit element generates different impedance values according to the mixed signal.

### CROSS REFERENCE TO RELATED APPLICATIONS

This Application claims priority of Taiwan Patent Application No. 104118459 filed on Jun. 8, 2015, the entirety of which is incorporated by reference herein.

### BACKGROUND OF THE INVENTION

Field of the Invention

The disclosure generally relates to a mobile device, and more particularly, to a mobile device for reducing the number of transmission lines.

Description of the Related Art

With advancements in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

In order to design a mobile device for covering a variety of frequency bands, using tunable antenna elements is a general solution for antenna designers nowadays. However, the tunable antenna element requires an independent control signal line. If other power signal lines and RF (Radio Frequency) signal lines are added, there will be too many transmission lines disposed in the small interior space of a mobile device, thereby causing some design problems.

### BRIEF SUMMARY OF THE INVENTION

To overcome the problem of prior art, in a preferred embodiment, the invention is directed to a mobile device including an antenna structure, a tunable circuit element, a bias tee element, an inductive element, and a capacitive element. The tunable circuit element is embedded in the antenna structure. The bias tee element has a first input terminal for receiving a power signal, a second input terminal for receiving an RF (Radio Frequency) signal, and an output terminal for outputting a mixed signal. The inductive element is configured to remove high-frequency noise from the power signal. The capacitive element is configured to remove low-frequency noise from the RF signal. The output terminal of the bias tee element is coupled to a feeding point on the antenna structure. The antenna structure is excited by the mixed signal. The tunable circuit element generates different impedance values according to the mixed signal.

In some embodiments, the inductive element and the capacitive element are inner components of the bias tee element. The inductive element is coupled between the first input terminal and the output terminal of the bias tee element. The capacitive element is coupled between the second input terminal and the output terminal of the bias tee element.

In some embodiments, the tunable circuit element is a PIN diode.

In some embodiments, when the power signal is at a low voltage, the tunable circuit element is open and the antenna structure operates in a low-frequency band. When the power signal is at a high voltage, the tunable circuit element is closed and the antenna structure operates in a high-frequency band.

In some embodiments, the low-frequency band is from about 704 MHz to about 894 MHz, and the high-frequency band is from about 790 MHz to about 960 MHz.

In some embodiments, the antenna structure includes a feeding element, a main radiation element, and a shorting element. The feeding point is positioned at a first end of the feeding element. A second end of the feeding element is coupled to a first connection point on the main radiation element. A first end of the shorting element is coupled to a ground voltage. A second end of the shorting element is coupled to a second connection point on the main radiation element. The tunable circuit element is embedded in a median portion of the shorting element.

In some embodiments, the tunable circuit element is a BST (Barium Strontium Titanate) variable capacitor.

In some embodiments, when a voltage of the power signal increases, a capacitance of the tunable circuit element decreases and an operation frequency of the antenna structure increases. When the voltage of the power signal decreases, the capacitance of the tunable circuit element increases and the operation frequency of the antenna structure decreases.

In some embodiments, the antenna structure includes a feeding element, a main radiation element, a capacitor, a connection element, and a shorting element. The feeding point is positioned at a first end of the feeding element. A second end of the feeding element is coupled to the tunable circuit element. The tunable circuit element is embedded in a median portion of the main radiation element. A third end of the feeding element is coupled through the capacitor to a first end of the connection element. A second end of the connection element is coupled to a connection point on the main radiation element. A first end of the shorting element is coupled to a ground voltage. A second end of the shorting element is coupled to the first end of the connection element.

In some embodiments, the tunable circuit element is a three-port element. A first port and a second port of the tunable circuit element are coupled to the main radiation element. A control port of the tunable circuit element is coupled to the second end of the feeding element.

### BRIEF DESCRIPTION OF DRAWINGS

The invention can be more fully understood by reading the subsequent detailed description and examples with references made to the accompanying drawings, wherein:

FIG. 1 is a diagram of a mobile device according to an embodiment of the invention;

FIG. 2 is a diagram of an antenna structure according to an embodiment of the invention;

FIG. 3 is a diagram of return loss of an antenna structure according to an embodiment of the invention;

FIG. 4 is a diagram of an antenna structure according to an embodiment of the invention; and

FIG. 5 is a diagram of return loss of an antenna structure according to an embodiment of the invention.

### DETAILED DESCRIPTION OF THE INVENTION

In order to illustrate the foregoing and other purposes, features and advantages of the invention, the embodiments and figures of the invention will be described in detail as follows.

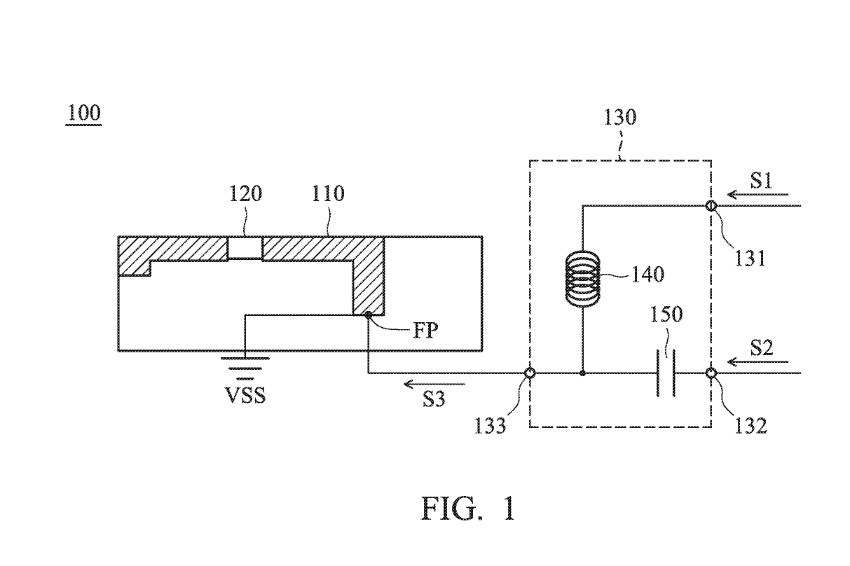

FIG. 1 is a diagram of a mobile device 100 according to an embodiment of the invention. The mobile device 100 may be a smartphone, a tablet computer, or a notebook computer. As shown in FIG. 1, the mobile device 100 includes an antenna structure 110, a tunable circuit element 120, a bias tee element 130, an inductive element 140, and a capacitive element 150. It should be understood that the mobile device 100 may further include other components, such as a processor, a display device, a touch control module, a battery, a speaker, and a housing, although they are not displayed in FIG. 1.

The antenna structure 110 may be made of a conductive material, such as copper, silver, aluminum, iron, or their alloys. The antenna structure 110 may be disposed on a dielectric substrate, such as a PCB (Printed Circuit Board) or an FR4 (Flame Retardant 4) substrate. The type and shape of the antenna structure 110 are not limited in the invention. For example, the antenna structure 110 may be a monopole antenna, a dipole antenna, a loop antenna, a patch antenna, or a helical antenna. The tunable circuit element 120 is embedded in the antenna structure 110, and is configured to generate different impedance values. The bias tee element 130 has a first input terminal 131 for receiving a power signal S1, a second input terminal 132 for receiving an RF (Radio Frequency) signal S2, and an output terminal 133 for outputting a mixed signal S3. Generally, the power signal S1 is a low-frequency signal, the RF signal S2 is a high-frequency signal, and the mixed signal S3 is a simple linear superposition of the power signal S1 and the RF signal S2. The output terminal 133 of the bias tee element 130 is coupled to a feeding point FP on the antenna structure 110. The antenna structure 110 is excited by the mixed signal S3 (Especially for the RF signal S2). The tunable circuit element 120 generates different impedance values according to the mixed signal S3 (Especially for the power signal S1). The inductive element 140 may be a coil inductor or a chip inductor. The inductive element 140 is configured to remove the high-frequency noise from the power signal S1. The capacitive element 150 may be a parallel-plate capacitor or a chip capacitor. The capacitive element 150 is configured to remove the low-frequency noise from the RF signal S2. In the embodiment of FIG. 1, the inductive element 140 and the capacitive element 150 are inner components of the bias tee element 130. The inductive element 140 is coupled between the first input terminal 131 and the output terminal 133 of the bias tee element 130. The capacitive element 150 is coupled between the second input terminal 132 and the output terminal 133 of the bias tee element 130. In alternative embodiments, adjustments are made such that the inductive element 140 and the capacitive element 150 are external components independent of the bias tee element 130.

In the above design of the mobile device 100, by using the bias tee element 130, the low-frequency power signal Si is combined with the high-frequency RF signal S2, so as form a single mixed signal S3. There is only one transmission line required for delivering the mixed signal S3. With such a design, the antenna structure 110 can be excited and the impedance value of the tunable circuit element 120 can be controlled at the same time. The antenna structure 110 further operates in multiple frequency bands in response to different impedance values of the tunable circuit element 120. The invention can prevent tunable antenna elements from having too many transmission lines in conventional designs, and it can further reduce the consumption of design space in the mobile device 100. The invention is suitable for application in a variety of small-size mobile communication devices.

The following embodiments describe the arrangements of the antenna structure 110 and the tunable circuit element 120. It should be understood that these embodiments are exemplary and used to illustrate the detailed features of the invention, but they are not used to limit the scope of the present patent application.

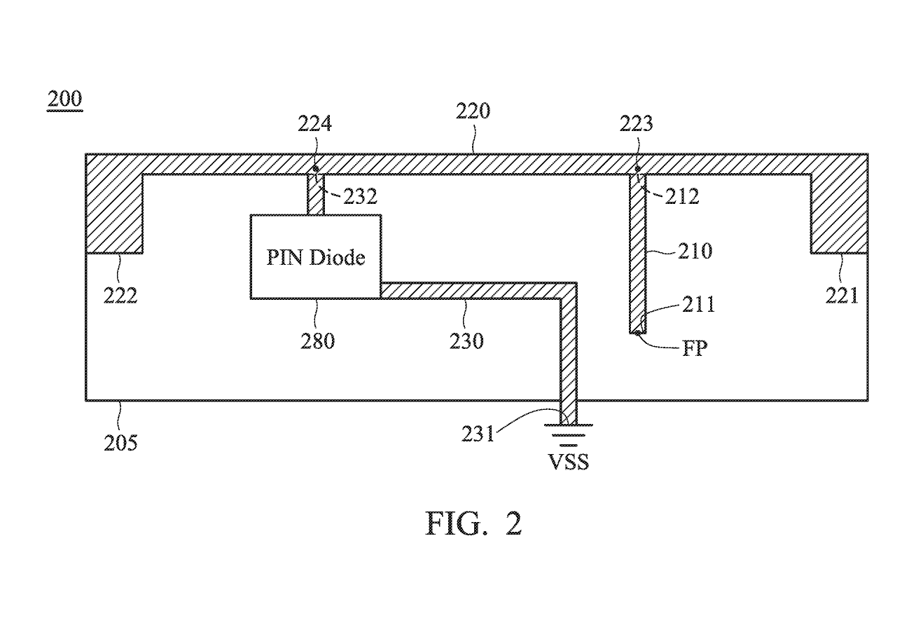

FIG. 2 is a diagram of an antenna structure 200 according to an embodiment of the invention. The antenna structure 200 may be applied to the mobile device 100 of FIG. 1. In the embodiment of FIG. 2, a tunable circuit element 280 is a PIN diode. The antenna structure 200 includes a feeding element 210, a main radiation element 220, and a shorting element 230. The feeding element 210, the main radiation element 220, and the shorting element 230 are made of metal materials, and they are disposed on a dielectric substrate 205. The main radiation element 220 substantially has an inverted U-shape. The main radiation element 220 has a first end 221 and a second end 222, and both the first end 221 and the second end 222 are open. The main radiation element 220 further has a first connection point 223 and a second connection point 224 thereon. The first connection point 223 and the second connection point 224 are disposed at different positions on the main radiation element 220. The feeding element 210 substantially has a straight-line shape. The feeding element 210 is substantially perpendicular to the main radiation element 220. The feeding element 210 has a first end 211 and a second end 212. A feeding point FP of the antenna structure 200 is positioned at the first end 211 of the feeding element 210. The second end 212 of the feeding element 210 is coupled to the first connection point 223 on the main radiation element 220. The feeding point FP of the antenna structure 200 may be coupled to an output terminal of a bias tee element, so as to receive a mixed signal, as mentioned in the embodiment of FIG. 1. The shorting element 230 substantially has an N-shape. The shorting element 230 has a first end 231 and a second end 232. The first end 231 of the shorting element 230 is coupled to a ground voltage VSS. The second end 232 of the shorting element 230 is coupled to the second connection point 224 on the main radiation element 220. The tunable circuit element 280 is embedded in a median portion of the shorting element 230. More specifically, an anode of the tunable circuit element 280 (PIN diode) is coupled through an upper portion of the shorting element 230 to the second connection point 224, and a cathode of the tunable circuit element 280 is coupled through a lower portion of the shorting element 230 to the ground voltage VSS. The tunable circuit element 280 is selectively open or closed according to the mixed signal (Especially for the power signal S1). Therefore, the tunable circuit element 280 can provide different impedance values, and the antenna structure 200 can operate in multiple frequency bands.

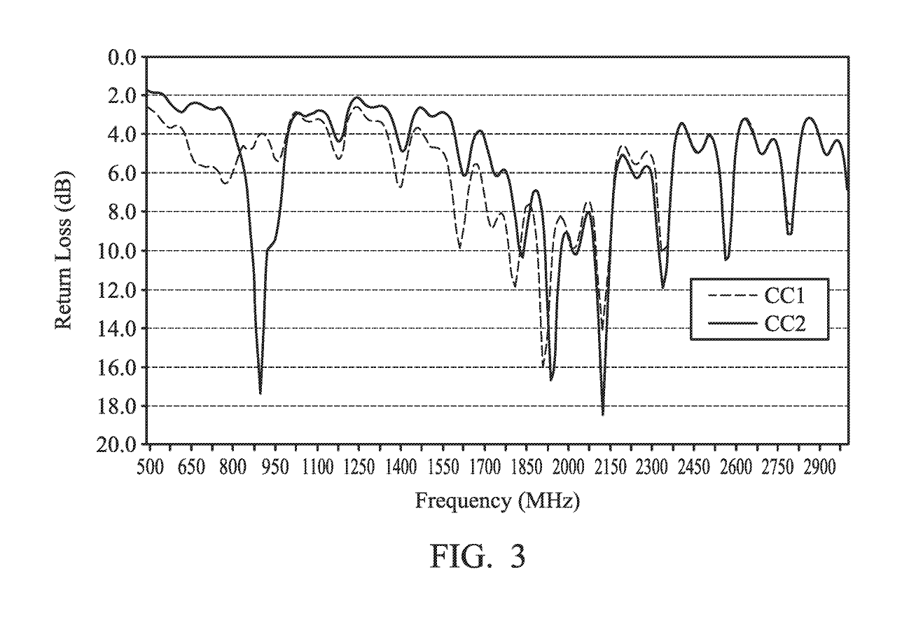

FIG. 3 is a diagram of return loss of the antenna structure 200 according to an embodiment of the invention. The horizontal axis represents the operation frequency (MHz), and the vertical axis represents the return loss (dB). Please refer to FIG. 2 and FIG. 3 together. When the power signal of the mixed signal is at a low voltage (e.g., lower than 0.7 V), the tunable circuit element 280 is open and the antenna structure 200 operates in a low-frequency band, as showed by a first curve CC1. Conversely, when the power signal of the mixed signal is at a high voltage (e.g., higher than 0.7 V), the tunable circuit element 280 is closed and the antenna structure 200 operates in a high-frequency band, as shown by a second curve CC2. In some embodiments, the low-frequency band is from about 704 MHz to about 894 MHz (American Standard), and the high-frequency band is from about 790 MHz to about 960 MHz (European Standard). Accordingly, by adjusting the power signal of the mixed signal, the antenna structure 200 can cover LTE (Long Term Evolution) frequency bands of both American and European standards, without changing the antenna size.

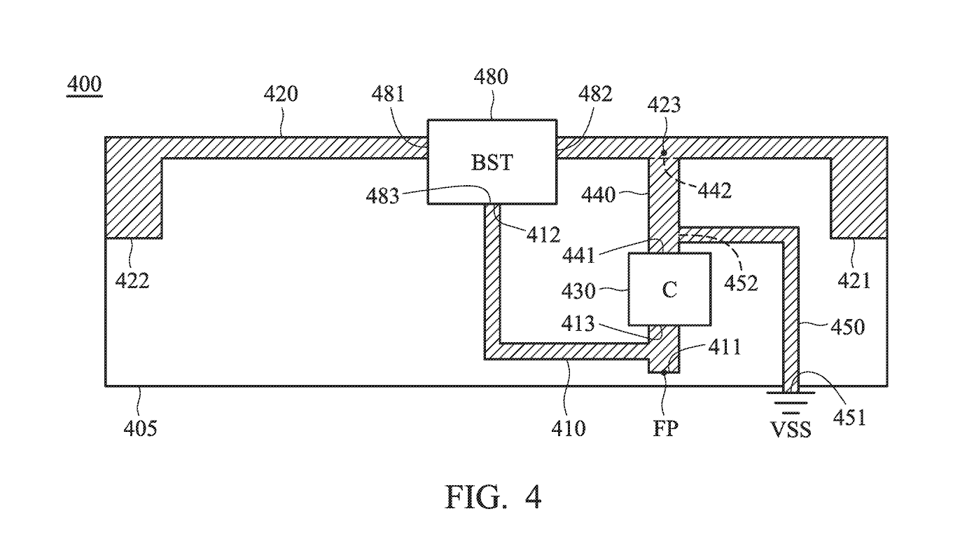

FIG. 4 is a diagram of an antenna structure 400 according to an embodiment of the invention. The antenna structure 400 may be applied to the mobile device 100 of FIG. 1. In the embodiment of FIG. 4, a tunable circuit element 480 is a BST (Barium Strontium Titanate) variable capacitor. The antenna structure 400 includes a feeding element 410, a main radiation element 420, a capacitor 430, a connection element 440, and a shorting element 450. The feeding element 410, the main radiation element 420, the connection element 440, and the shorting element 450 are made of metal materials, and they are disposed on a dielectric substrate 405. The main radiation element 420 substantially has an inverted U-shape. The main radiation element 420 has a first end 421 and a second end 422, and both the first end 421 and the second end 422 are open. The main radiation element 420 further has a connection point 423 thereon. The tunable circuit element 480 is embedded in a median portion of the main radiation element 420. The feeding element 410 substantially has an N-shape. The feeding element 410 has a first end 411, a second end 412, and a third end 413. A feeding point FP of the antenna structure 400 is positioned at the first end 411 of the feeding element 410. The second end 412 of the feeding element 410 is coupled to the tunable circuit element 480. The feeding point FP of the antenna structure 400 may be coupled to an output terminal of a bias tee element, so as to receive a mixed signal, as mentioned in the embodiment of FIG. 1. A power signal of the mixed signal may be transmitted through the second end 412 of the feeding element 410 to the tunable circuit element 480, thereby controlling the impedance value of the tunable circuit element 480. More specifically, the tunable circuit element 480 is a three-port element and has a first port 481, a second port 482, and a control port 483. The first port 481 and the second port 482 (i.e., two terminals of a variable capacitor) of the tunable circuit element 480 are coupled to the main radiation element 420. The control port 483 of the tunable circuit element 480 is coupled to the second end 412 of the feeding element 410, so as to receive the power signal of the mixed signal. For example, the tunable circuit element 480 can provide different capacitances according to the power signal, such that the antenna structure 400 can operate in multiple frequency bands. The capacitor 430 has a fixed capacitance, and it is used as a DC (Direct Current) blocking element of the feeding element 410. The connection element 440 substantially has a straight-line shape. The connection element 440 is substantially perpendicular to the main radiation element 420. The connection element 440 has a first end 441 and a second end 442. The third end 413 of the feeding element 410 is coupled through the capacitor 430 to the first end 441 of the connection element 440. The second end 442 of the connection element 440 is coupled to the connection point 423 on the main radiation element 420. The shorting element 450 substantially has an L-shape. The shorting element 450 has a first end 451 and a second end 452. The first end 451 of the shorting element 450 is coupled to a ground voltage VSS. The second end 452 of the shorting element 450 is coupled to the first end 441 of the connection element 440.

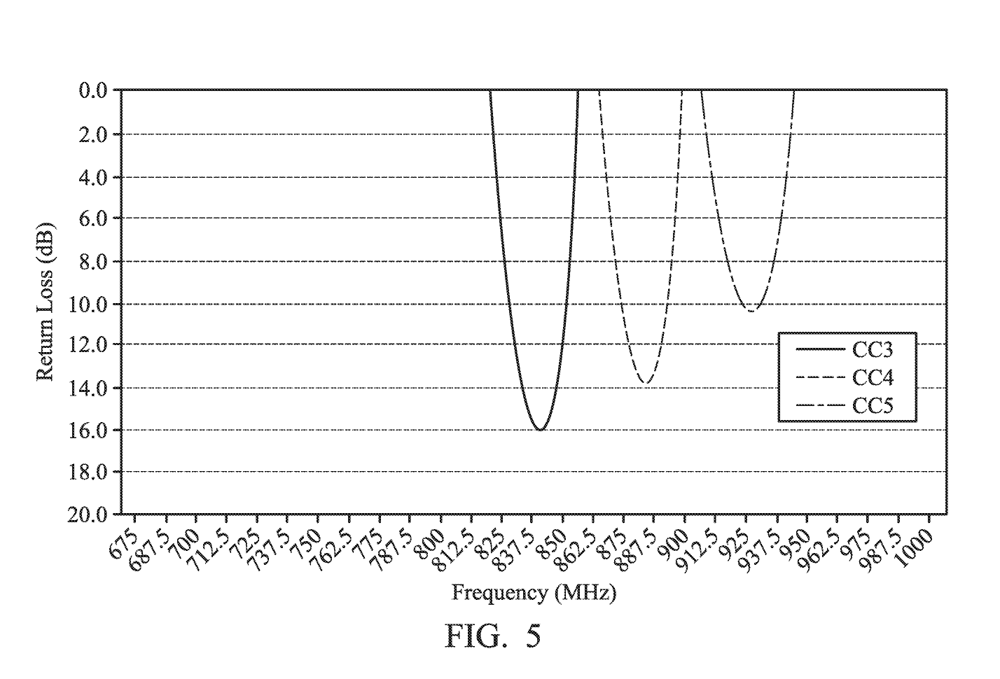

FIG. 5 is a diagram of return loss of the antenna structure 400 according to an embodiment of the invention. The horizontal axis represents the operation frequency (MHz), and the vertical axis represents the return loss (dB). Please refer to FIG. 4 and FIG. 5 together. A third curve CC3 represents the characteristic of the antenna structure 400 when the voltage of the power signal is set to 0 V, and in the case, the capacitance of the tunable circuit element 480 is about 8 pF. A fourth curve CC4 represents the characteristic of the antenna structure 400 when the voltage of the power signal is set to 10 V, and in the case, the capacitance of the tunable circuit element 480 is about 5 pF. A fifth curve CC5 represents the characteristic of the antenna structure 400 when the voltage of the power signal is set to 18 V, and in the case, the capacitance of the tunable circuit element 480 is about 2 pF. That is, when the voltage of the power signal of the mixed signal increases, the capacitance of the tunable circuit element 480 decreases and the operation frequency of the antenna structure 400 increases, and when the voltage of the power signal of the mixed signal decreases, the capacitance of the tunable circuit element 480 increases and the operation frequency of the antenna structure 400 decreases. Accordingly, by adjusting the power signal of the mixed signal, the antenna structure 400 can cover high-frequency and low-frequency bands, such as LTE frequency bands of American and European standards, without changing the antenna size.

The invention provides a novel mobile device and a novel antenna structure therein. In comparison to conventional tunable antenna elements, the invention has at least the advantages of: (1) reducing the number of transmission lines, (2) reducing the total area of the antenna structure, (3) increasing the operation bandwidth of the antenna structure, (4) simplifying the antenna structure, and (5) decreasing the manufacturing cost. Therefore, the invention is suitable for application in a variety of small-size mobile communication devices.

Note that the above element sizes, element shapes, and frequency ranges are not limitations of the invention. An antenna designer can fine-tune these settings or values according to different requirements. It should be understood that the mobile device and antenna structure of the invention are not limited to the configurations of FIGS. 1-5. The invention may include any one or more features of any one or more embodiments of FIGS. 1-5. In other words, not all of the features displayed in the figures should be implemented in the mobile device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
an antenna structure;
a tunable circuit element, embedded in the antenna structure;
a bias tee element, wherein the bias tee element has a first input terminal for receiving a power signal, a second input terminal for receiving an RF (Radio Frequency) signal, and an output terminal for outputting a mixed signal;
an inductive element, removing high-frequency noise from the power signal; and
a capacitive element, removing low-frequency noise from the RF signal;
wherein the output terminal of the bias tee element is coupled to a feeding point on the antenna structure, the antenna structure is excited by the mixed signal, and the tunable circuit element generates different impedance values according to the mixed signal.

2. The mobile device as claimed in claim 1, wherein the inductive element and the capacitive element are inner components of the bias tee element, the inductive element is coupled between the first input terminal and the output terminal of the bias tee element, and the capacitive element is coupled between the second input terminal and the output terminal of the bias tee element.

3. The mobile device as claimed in claim 1, wherein the tunable circuit element is a PIN diode.

4. The mobile device as claimed in claim 3, wherein when the power signal is at a low voltage, the tunable circuit element is open and the antenna structure operates in a low-frequency band, and wherein when the power signal is at a high voltage, the tunable circuit element is closed and the antenna structure operates in a high-frequency band.

5. The mobile device as claimed in claim 4, wherein the low-frequency band is from about 704 MHz to about 894 MHz, and the high-frequency band is from about 790 MHz to about 960 MHz.

6. The mobile device as claimed in claim 3, wherein the antenna structure comprises:
a feeding element, wherein the feeding point is positioned at a first end of the feeding element;
a main radiation element, wherein a second end of the feeding element is coupled to a first connection point on the main radiation element; and
a shorting element, wherein a first end of the shorting element is coupled to a ground voltage, and a second end of the shorting element is coupled to a second connection point on the main radiation element, and the tunable circuit element is embedded in a median portion of the shorting element.

7. The mobile device as claimed in claim 1, wherein the tunable circuit element is a BST (Barium Strontium Titanate) variable capacitor.

8. The mobile device as claimed in claim 7, wherein when a voltage of the power signal increases, a capacitance of the tunable circuit element decreases and an operation frequency of the antenna structure increases, and wherein when the voltage of the power signal decreases, the capacitance of the tunable circuit element increases and the operation frequency of the antenna structure decreases.

9. The mobile device as claimed in claim 7, wherein the antenna structure comprises:
a feeding element, wherein the feeding point is positioned at a first end of the feeding element, and a second end of the feeding element is coupled to the tunable circuit element;
a main radiation element, wherein the tunable circuit element is embedded in a median portion of the main radiation element;
a capacitor;
a connection element, wherein a third end of the feeding element is coupled through the capacitor to a first end of the connection element, and a second end of the connection element is coupled to a connection point on the main radiation element; and
a shorting element, wherein a first end of the shorting element is coupled to a ground voltage, and a second end of the shorting element is coupled to the first end of the connection element.

10. The mobile device as claimed in claim 9, wherein the tunable circuit element is a three-port element, a first port and a second port of the tunable circuit element are coupled to the main radiation element, and a control port of the tunable circuit element is
